(19) United States
(12) Patent Application Publication
(10) Pub. No.: US 2012/0319419 A1
(43) Pub. Date: Dec. 20, 2012

(54) TOOL ATTACHMENT DEVICE FOR ELONGATED HANDLES

(76) Inventor: Iraj H. Golestani, Phoenix, AZ (US)

(21) Appl. No.: 13/328,567

(22) Filed: Dec. 16, 2011

Related U.S. Application Data
(60) Provisional application No. 61/425,945, filed on Dec. 22, 2010.

(51) Int. Cl. B66F 19/00

(52) U.S. Cl. 294/209

(57) ABSTRACT

A device for securely attaching a tool attachment to an elongated handle of a broom or rake. The device typically comprises a core element with a first lower end designed to fasten the device to an elongated handle, and a second upper end designed to securely hold a tool attachment in place. The second upper end further comprises a sidewall, an enclosed top, an inner surface, and a tool receiving groove. The device also comprises a securing member that acts as a spacer and presses the tool attachment against the second upper end when the device is fastened to an elongated handle. Preferably, the core element also comprises gripping grooves along its exterior. Furthermore, the tool attachments are preferably common and inexpensive, such as nails and hooks.

### RELATED APPLICATION DATA

This application is based on and claims priority to U.S. Provisional Patent Application No. 61/425,945 filed on Dec. 22, 2010.

### FIELD OF THE INVENTION

The present invention is directed to a device for securely attaching a tool to an elongated handle. More specifically, the elongated handle is often the handle of a broom, rake, or other cleaning apparatus, and the tool is generally designed to stab, hook, perforate, or cut.

### BACKGROUND OF THE INVENTION

Landscaping and janitorial services often involve arduous work and the use of many tools. Conventional push brooms are used for sweeping shop floors, public buildings, garden patios, roads, sidewalks, etc. Oftentimes, however, the sweeper may encounter trash and/or debris that requires separation from ordinary dirt or dust particles. Usually, the sweeper must set the broom aside and bend down to collect the trash, causing fatigue and muscle aches. Likewise, rakes are generally used for gathering leaves and smoothing gravel or sand. Gardening or landscaping often requires removing trash from bushes and shrubbery or tending to occasional overgrowth. Again, this may require the landscaper to put down the rake and wade through shrubbery to reach the trash, potentially damaging the plants and/or landscaper, or use a ladder to reach areas out of arm's length. The time and money spent grabbing a ladder or replacing a damaged bush can represent a significant economic loss to the landscaper or janitor over time.

Various combination tools have been developed in an attempt to address some of these concerns. For instance, U.S. Pat. No. 4,185,448 discloses a combination rake and trash pick-up tool designed to grab trash or leaves through a jaw-like clamping mechanism. Similarly, U.S. Pat. No. 5,502,857 discloses a scraper device for a push broom designed to remove debris that sticks to the surface being swept. Furthermore, U.S. Pat. No. 5,743,580 teaches a handle and post assembly that can to different tools, including shovels, spade, and rakes. Thus, the prior art teaches certain devices capable of performing multiple janitorial or landscaping tasks. The prior art suffers from several disadvantages, however, prominently including complexity and high-cost.

Landscapers and janitors are often hard on their tools. As such, the ideal tools are durable, yet relatively cheaply and easily replaced. Moreover, a combination tool is only useful if the tool attachments can be inserted or removed in less time than it takes to obtain the second tool (e.g., ladder). The present invention addresses these needs by providing a tool attachment device for elongated handles that is durable, strong, inexpensive, and allows for the quick and easy insertion of various tool attachments. Moreover, some of the tool attachments can be things as simple as a nail or hook, common items in any hardware store.

### SUMMARY OF THE INVENTION

The present invention is directed to a device for securely attaching a tool attachment to an elongated handle. In a preferred embodiment, the device comprises a core element with a hollow inner portion, an exterior surface, a first lower end, and a second upper end. The first lower end is designed to securely attach the device to an elongated handle through the handle receiving opening. The second upper end comprises a sidewall, enclosed top, an inner surface, and a tool receiving groove extending through a portion of the enclosed top and sidewall. The tool receiving grove allows the user to insert a tool attachment without the need to completely disengage the device from the elongated handle. The device also comprises a securing member designed to press the tool attachment against the inner surface of the upper receiving end when the device is fastened to an elongated handle.

Advantageously, in a further preferred embodiment, the first lower end comprises interior threads designed to engage the threads of an elongated handle. Preferably, the elongated handle is the handle of a broom, rake, shovel, spade, hoe, or similar apparatus. In a preferred embodiment, the core element further comprises a locking member channel and locking member designed as a secondary means to hold the tool attachment in place. Preferably, the core element is a solid piece of material composed of metal, plastic, or combinations thereof.

In a further preferred embodiment, the exterior surface of the core element comprises gripping grooves that allow to the user to easily and tightly engage or disengage the device onto an elongated handle. The tool attachments are preferably selected from the group consisting of a nail, a rounded hook, an acute hook, a circular blade, and a spur roller. These various tool attachments allow the user to pick up trash, pull down objects, and cut/perforate various materials with minimal effort.

### BRIEF DESCRIPTION OF THE DRAWINGS

The accompanying drawings, described below, illustrate preferred embodiments of the present invention. These drawings depict various features and further advantages of the present invention. Reference numbers indicate identical or functionally similar elements. It will be understood that no limitation to the scope of the invention is intended thereby. These drawings depict various features and further advantages of the present invention. The invention is not limited to the particular embodiments disclosed in these drawings, as it should be understood by one skilled in the art that additional features, modifications, and alternative embodiments are contemplated by the invention as disclosed herein.

FIG. 1 is a photograph of a fully assembled embodiment of the invention, including the optional tool attachment and elongated handle.

FIG. 2 is a photograph of the core element with the second upper end removed, showing a view of the hollow interior of the core element. The first lower end is farthest away from the viewer.

FIG. 3 is a photograph of a preferred embodiment of the invention, depicting the core element.

FIG. 4 is a photograph of the core element, looking downward upon the second upper end, clearly depicting the enclosed cap and tool receiving groove.

FIG. 5 is a photograph of the core element, including the locking member and securing member.

### DETAILED DESCRIPTION OF THE PREFERRED EMBODIMENTS

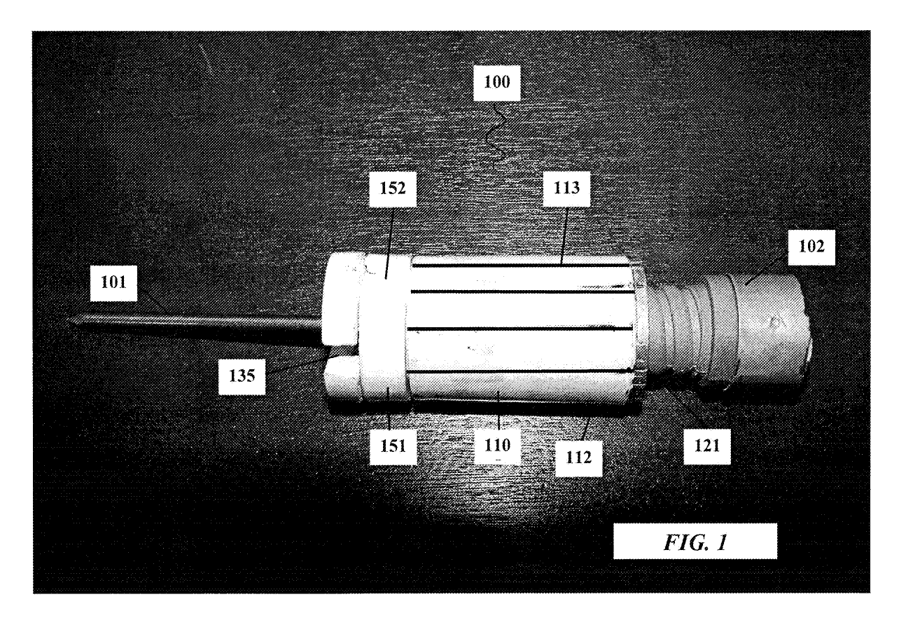

The present invention is directed to a device for securely fastening a tool attachment to a handle, particularly an elongated handle of a broom, rake, or other cleaning apparatus. As shown in FIG. 1, depicting a fully assembled embodiment 100 of the invention, the device is removably attached to a tool attachment 101 and elongated handle 102. The elongated handle 102 may be the handle of any common cleaning or gardening apparatus, including a broom, rake, shovel, spade, hoe, etc. The tool attachment 101 can be any tool that a user may find beneficial for a particular job. For example, when sweeping any particular area, it is often desirable to separate dirt and dust particles from larger pieces of trash. Thus, a tool attachment 101 such as a nail allows the user flip the broom upside down and pick up larger pieces of trash through a stabbing motion without the need to bend over. Similarly, yard work often encompasses chores such as raking leaves and tending to trees and bushes. Thus, a tool attachment such as a hook may allow the user to reach distant objects instead of using a ladder or trouncing through shrubbery. Moreover, some situations may require the use of a cutting device to trim trees and bushes, or to cut/perforate material such as plastic. Thus, in a further preferred embodiment, the tool attachment is selected from the group consisting of a nail, a rounded hook, an acute hook, a circular blade, and a spur roller.

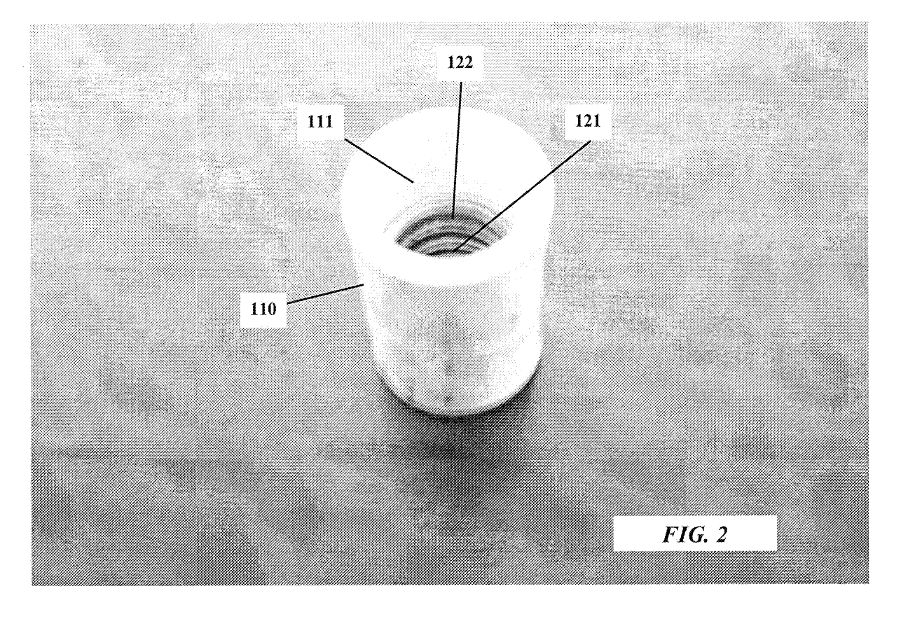

In a preferred embodiment, the device comprises a core element 110 with a hollow inner portion 111 (see FIG. 2), and an exterior surface 112. Preferably, the core element 110 is shaped similarly to the elongated handle 102 to which it attaches. For example, most elongated handles are cylindrically shaped, and thus, the core element 110 is preferably cylindrical as well. Likewise, the diameter of the core element 110 is preferably similar to that of most standard elongated handles. For example, the core element 110 preferably has an outer diameter between ½ and 3 inches, and more preferably between 1 and 2 inches. As would be known to those skilled in the art, however, the core element may perform equally well in a hollow, tubular form, taking the shape of any geometrical prism (e.g., triangular prism, rectangular prism, etc.).

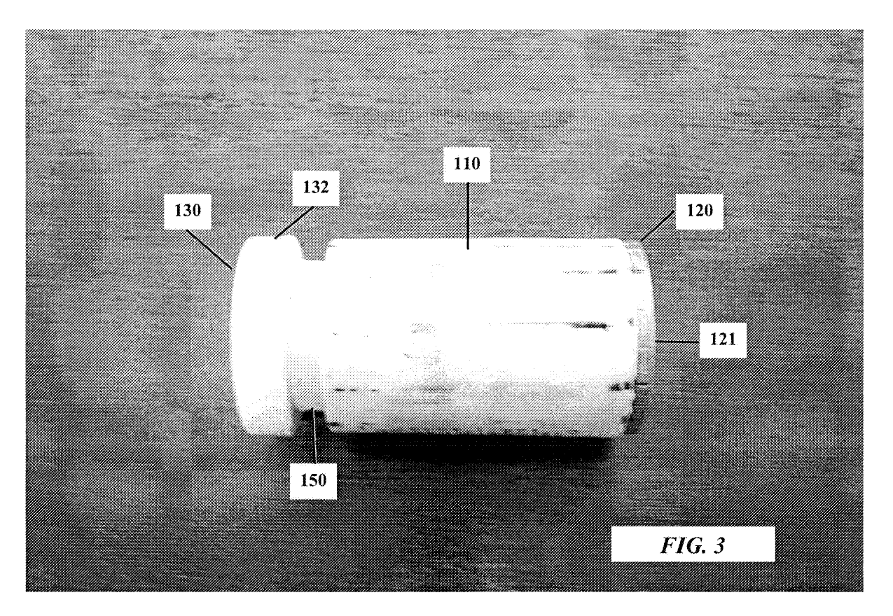

Perhaps best illustrated in FIG. 3, the core element 110 has a first lower end 120 and a second upper end 130. The first lower end 120 is configured to securely attach the device to an elongated handle 102 through the handle receiving opening 121. Elongated handles are often threaded and capped at the user end. Thus, the first lower end 120 preferably comprises a threaded inner surface 122 (see FIG. 2) designed to engage the threads of an elongated handle.

Other means of attachment may be employed when the elongated handle is not threaded. In such situations, the handle receiving opening 121 of the first lower end 120 may be slid over an elongated handle and secured by a screw clamp, available at any hardware store. Alternatively, a user could drill a hole through the core element 110 and elongated handle and fasten the device in place with the use of a bolt and nut.

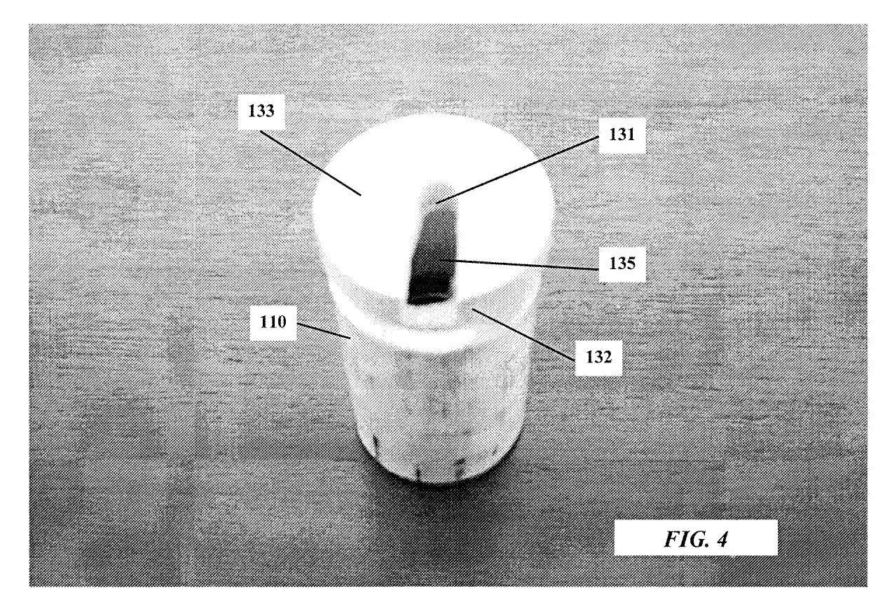

Now referring to FIG. 4, the second upper end 130 comprises a sidewall 132, an enclosed top 133, and an inner surface 134 (not shown). The second upper end 130 also has a tool receiving groove 135 extending through a portion of the enclosed top 133. The tool receiving groove 135 may extend through nearly the entire diameter of the enclosed top 133. Preferably, however, the tool receiving groove 135 extends only to the center 131 of the second upper end 130, wherein the tool is held in place in the center of the device. The tool receiving groove 135 could simply be a hole in the enclosed top 133, allowing for the insertion of a straight tool attachment when the core element 110 is completely disengaged from an elongated handle. Preferably, however, the tool receiving groove is configured to securely receive the tool attachment without completely disengaging the core element from the elongated handle.

As used herein, “configured to securely receive without completely disengaging the core element from the elongated handle” means that the tool receiving groove 135 extends through a portion of the sidewall 132. The portion of the groove 135 extending into the sidewall 132 is preferably slightly wider than the width of the groove 135 at the inner surface 134 so a tool attachment can be slid into the tool receiving groove 135, yet still be held firmly in place by the inner surface 134. By way of example, the tool receiving groove 135 allows the user to slide in a tool attachment (e.g., a nail), but is narrow enough at the inner surface 134 wherein the tool attachment cannot slide out of the core element 110 in a longitudinal direction when the device is fully assembled.

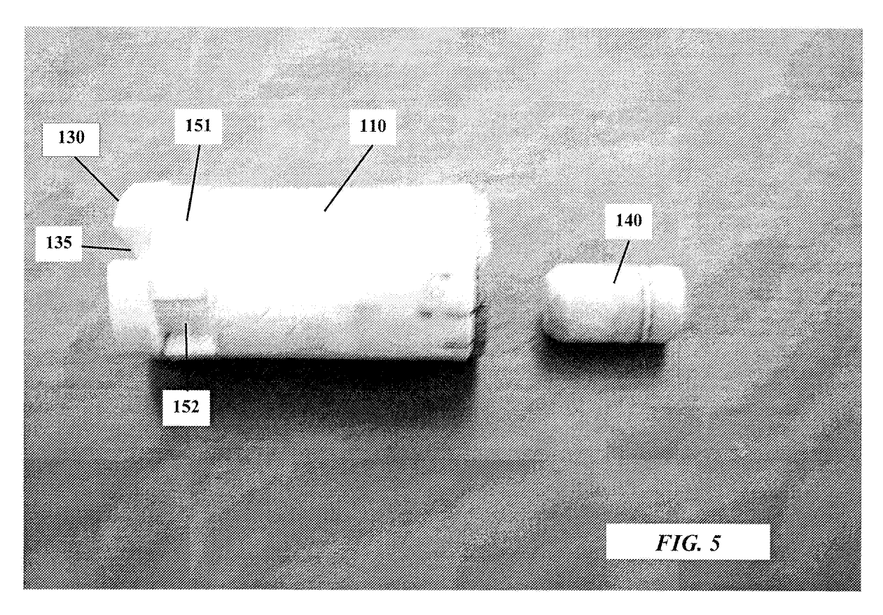

As depicted in FIG. 5, the device further comprises a securing member 140 that is moveably positioned in the hollow inner portion 111 (see FIG. 2) of the core element 110 to function as a spacer to secure a tool attachment in place. When the device is attached to an elongated handle, the spacer is pressed toward the second upper end 130 of the core element 110, until it contacts the inner surface 134 (not shown) of the second upper end 130. Thus, the securing member 140 functions to tightly hold the tool attachment against the inner surface 134 (not shown) of the second upper end 130, preventing the tool attachment from moving within the core element 110.

The first lower end of the core element and the core element as a whole may be composed of any solid material. Ideally, the material is both strong and inexpensive. Thus, the first lower end and the core element as a whole are preferably composed of metal, plastic, and/or combinations thereof. Moreover, the core element 110, including the first lower end 120 and second upper end 130, is preferably one solid piece of material shaped as shown in FIG. 3, rather than comprised of individual components.

In a further preferred embodiment as depicted in FIGS. 1 and 3, the core element 110 further comprises a locking member channel 150 and locking member 151. The locking member 151 is seated within the locking member channel 150 and designed to prevent the tool attachment 101 from falling out of the device. As previously described, the securing member 140 (see FIG. 5) holds the tool attachment 101 in place, so the locking channel generally functions as a secondary means to secure the tool attachment 101 within the device. When the user is inserting or removing a tool attachment 101, the locking member 151 should be rotated so the gap 152 in the locking member 151 aligns with the tool receiving groove 135 of the second upper end 130 (i.e. open position). Once the tool attachment 101 has been placed and secured within the device, the user rotates the locking member 151 to a closed position where the tool attachment 101 cannot slide out of the tool receiving groove 135. The locking member 151 is preferably as wide or slightly wider than the depth through which the tool receiving groove 135 is cut into the sidewall 132 of the second upper end 130. As an illustrative example, the depth of the tool receiving groove 135 is 3/16 of an inch into the sidewall 132 of the second upper end 130 and the locking member 151 is ¼ inches wide. Likewise, the locking member channel 150 is just wide enough to allow the locking member 151 to rotate around the second upper end 130. Using the same example, the locking member channel 150 might be 9/32 or 5/16 inches wide. One skilled in the art would recognize that many different dimensions could work equally as well.

Advantageously, as illustrated in FIG. 1, the exterior surface 112 of the core element comprises gripping grooves 113 arranged longitudinally around the exterior surface 112 to enhance the user's grip on the device when attaching or detaching the device to an elongated handle 102. These gripping grooves 113 are particularly beneficial when the core element 110 is cylindrically shaped. The gripping grooves may comprise some sort of rubber jacket encasing the exterior surface of the core element. Preferably, however, the gripping grooves 113 are formed within the exterior surface 112 of the core element itself.

The disclosed invention is not intended to be limited to the particular embodiments described and illustrated herein. Although the foregoing describes the preferred embodiments of this invention, it will be understood that the broadest scope of this invention includes modifications. Such scope is limited only by the claims below as read in connection with the above specification. Moreover, many additional advantages of the present invention will be apparent to those skilled in the art in view of the above specification and claims herein.

What is claimed is:

1. A device for securely attaching a tool attachment to an elongated handle, the device comprising:
a core element having a first lower end, a second upper end and a hollow inner portion, the first lower end being configured to securely attach to the elongated handle, the first lower end comprising a handle receiving opening and the second upper end having a side wall, an enclosed top and an inner surface, the second upper end further comprising a tool receiving groove, the tool receiving groove extending through the side wall and through a portion of the top, the tool receiving groove being configured to securely receive the tool attachment without completely disengaging the core element from the elongated handle; and
a securing member, wherein the securing member is movably positioned in the hollow inner portion of the core element, the securing member being configured such that when the first lower end of the core element is securely attached to the elongated handle, the securing member is pressed up towards the inner surface of the second upper end of the core element to secure the tool attachment in place.

2. The device of claim 1, wherein the core element further comprises a locking member channel and a locking member seated in the locking member channel, wherein the locking member being configured to move in the locking member channel between a locked position and an opened position.

3. The device of claim 2, wherein the tool is removably attached.

4. The device of claim 2, wherein the elongated handle is removably attached.

5. The device of claim 1, wherein the top of the second upper end has a center and the tool receiving groove extends into the center of the top.

6. The device of claim 1, wherein the elongated handle is a broom handle.

7. The device of claim 1, wherein the first lower end of the core element has a threaded inner surface configured to engage the elongated handle.

8. The device of claim 1, wherein the first lower end of the device is composed of materials selected from the group consisting of metal, plastic, and/or combinations thereof.

9. The device of claim 1, wherein the core element is one solid piece of material.

10. The device of claim 1, wherein the core element is composed of materials selected from the group consisting of metal, plastic, and combinations thereof.

11. The device of claim 1, wherein the core element further comprises gripping groves on an exterior surface thereof, the gripping groves being longitudinal along the exterior surface and configured to aid gripping the core element when engaging or disengaging the device from the elongated handle or inserting an attachment tool.

12. The device of claim 1, further comprising a tool attachment positioned in the tool receiving groove.

13. The device of claim 12, wherein the tool attachment is a trash-picking attachment designed to pick up trash and/or debris by stabbing the trash and/or debris.

14. The device of claim 12, wherein the tool attachment is a hooking attachment designed to grab or pull objects out of a user's reach.

15. The device of claim 12, wherein the tool attachment is selected from the group consisting of a nail, a rounded hook, an acute hook, circular blade, and a spur roller.
